(19) United States
(12) Patent Application Publication
(10) Pub. No.: US 2026/0045254 A1
(43) Pub. Date: Feb. 12, 2026

(54) METHOD AND APPARATUS FOR PROVIDING VERBAL ORDER BASED ON SEAT POSITION

(71) Applicants: HYUNDAI MOTOR COMPANY, SEOUL (KR); KIA CORPORATION, SEOUL (KR)

(72) Inventor: Seong Soo Yae, Hwaseong-si (KR)

(73) Assignees: HYUNDAI MOTOR COMPANY, SEOUL (KR); KIA CORPORATION, SEOUL (KR)

(21) Appl. No.: 19/240,805

(22) Filed: Jun. 17, 2025

(30) Foreign Application Priority Data
Aug. 6, 2024 (KR) 10-2024-0104726

(51) Int. Cl. G10L 15/22; B60W 40/08; B60W 50/14; G06Q 10/0836; G10L 15/08; G10L 15/26

(52) U.S. Cl. CPC G10L 15/22; B60W 40/08; B60W 50/14; G06Q 10/0836; G10L 15/08; G10L 15/26; B60W 2540/21; B60W 2540/227; B60W 2554/406; G10L 2015/088; G10L 2015/221; G10L 2015/223

(57) ABSTRACT

A method for providing a verbal order based on seat position includes: identifying a seat position of each passenger; generating order information for each occupied seat based on the identified seat position of each passenger; and transmitting the order information to a store where the order is placed.

### CROSS-REFERENCE TO RELATED APPLICATION

This application claims priority to and the benefit of Korean Patent Application No. 10-2024-0104726, filed on Aug. 6, 2024, in the Korea Intellectual Property Office, the entire contents of which are incorporated herein by reference.

### TECHNICAL FIELD

The present disclosure relates to a method and an apparatus for providing a verbal order based on seat position. More specifically, the present disclosure relates to a speech recognition technology for placing orders using seat information and speech information.

### BACKGROUND

The statements in this section provide background information related to the present disclosure and do not necessarily constitute prior art.

As artificial intelligence technology advances, its application areas expand. In particular, conversation systems that enable a conversation with users through natural languages, such as chatbots or virtual assistants, are being used across various fields. For a conversation system to conduct a conversation with a user, it is desired to understand the user's utterance, namely, an input message, from the conversation system's perspective. Natural Language Understanding (NLU) requires the conversation system to derive the current context from a conversation between the conversation system and its user and the user's intent expected from that context; and analyze the input message based on the current context and/or intent.

The application of speech recognition services is expanding beyond the home into various industries, including the automotive industry. Also, telematics technology includes a range of functions. Examples of the functions include real-time navigation, information search through the Internet, and optimization of in-vehicle environments by utilizing the vehicle's location and weather information.

The existing vehicle infotainment system offers two ordering methods: a manual way and a verbal way. The manual way refers to a method in which the user directly inputs an order while viewing the navigation screen. The verbal way allows the user to place a verbal order by saying, for example, “two iced Americanos and two café lattes.” The verbal way reveals no difficulty if the driver alone places an order; however, if there are passengers in the vehicle other than the driver, the driver may feel burdened to remember and place the passengers' orders in addition to the driver's own order. Accordingly, there may be cases where the driver orders incorrectly or fails to place orders. In particular, when orders involve complex preferences, the likelihood of failure in ordering further increases.

### SUMMARY

An object of the present disclosure is to provide a method and an apparatus for providing a verbal order, which place orders from respective seat positions of the passengers using seat information and speech information.

Another object of the present disclosure is to provide a method and an apparatus for providing a verbal order, which allow passengers to receive items ordered from their seat position.

Technical objects to be achieved by the present disclosure are not limited to those described above, and other technical objects not mentioned above may also be clearly understood from the detailed descriptions given below by those having ordinary skill in the art to which the present disclosure belongs.

An embodiment of the present disclosure provides a method for providing a verbal order based on seat position. The method includes: identifying a seat position of each passenger; generating order information for each occupied seat based on the identified seat position of each passenger; and transmitting the order information to a store where the order is placed.

Another embodiment of the present disclosure provides an apparatus for providing a verbal order based on seat position. The apparatus includes: at least one memory storing instructions; and at least one processor. By executing the instructions, the at least one processor is configured to perform: identifying a seat position of each passenger; generating order information for each occupied seat based on the identified seat position of each passenger; and transmitting the order information to a store where the order is placed.

According to an embodiment of the present disclosure, by ordering products for each passenger's seat position, using seat information and utterance information, a conversation system may accurately recognize the orders.

According to an embodiment of the present disclosure, by having each passenger receive an ordered product at their seat location, processes for preparing and delivering the items may be managed efficiently.

The advantageous effects of the present disclosure are not limited to those described above; other advantageous effects of the present disclosure not mentioned above may be understood clearly by those having ordinary skill in the art from the descriptions given below.

### BRIEF DESCRIPTION OF THE DRAWINGS

FIG. 1 illustrates a structure of a speech recognition ordering system of a vehicle according to an embodiment of the present disclosure.

FIG. 2 illustrates a structure of a speech recognition ordering apparatus according to an embodiment of the present disclosure.

FIG. 3 illustrates a structure of a speech recognition system according to an embodiment of the present disclosure.

FIG. 4 illustrates a method for exchanging information between a vehicle and a reception desk of a store according to an embodiment of the present disclosure.

FIG. 5 illustrates a method for receiving an item using a pickup table according to an embodiment of the present disclosure.

FIG. 6 is a flow diagram for generating order information by a speech recognition ordering apparatus according to an embodiment of the present disclosure.

FIG. 7 is a flow diagram illustrating a process of receiving an ordered item from a store according to an embodiment of the present disclosure.

FIG. 8 is a block diagram illustrating a computing device that may be used for implementing a method of a speech recognition ordering apparatus according to the present disclosure.

### DETAILED DESCRIPTION

Hereinafter, embodiments of the present disclosure are described in detail with reference to the accompanying drawings. In the following description, like reference numerals designate like elements, although the elements are shown in different drawings. Further, in the following description of the embodiments, a detailed description of known functions and configurations incorporated therein has been omitted for the purpose of clarity and for brevity.

Additionally, various terms such as first, second, A, B, (a), (b), and the like, are used solely to differentiate one component from the other but not to imply or suggest the substances, order, or sequence of the components. Throughout this specification, when a part ‘includes’ or ‘comprises’ a component, the part is meant to further include other components, not to exclude thereof unless specifically stated to the contrary. The terms such as ‘unit’, ‘module’, and the like refer to one or more units for processing at least one function or operation, which may be implemented by hardware, software, or a combination thereof.

When a controller, component, device, element, part, unit, module, or the like of the present disclosure is described as having a purpose or performing an operation, function, or the like, the controller, component, device, element, part, unit, or module should be considered herein as being “configured to” meet that purpose or perform that operation or function. Each controller, component, device, element, part, unit, module, and the like may separately embody or be included with a processor and a memory, such as a non-transitory computer-readable media, as part of the apparatus.

The following detailed description, together with the accompanying drawings, is intended to describe embodiments of the present disclosure, and is not intended to represent the only embodiments in which the present disclosure may be practiced.

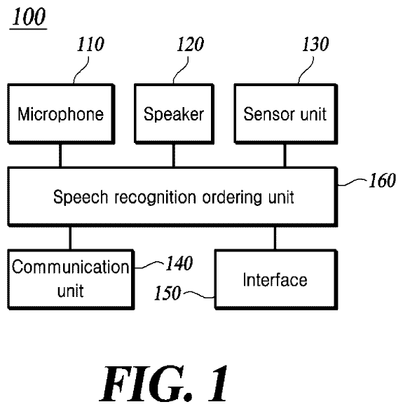

FIG. 1 illustrates a structure of a speech recognition ordering system of a vehicle according to an embodiment of the present disclosure.

A speech recognition ordering system 100 of a vehicle according to an embodiment of the present disclosure may include all or part of a microphone 110, a speaker 120, a sensor unit 130, a communication unit 140, an interface 150, and a speech recognition ordering unit 160. Not all blocks shown in FIG. 1 are essential components, and part of the blocks included in the speech recognition ordering system 100 may be added, modified, or deleted. The constituting elements shown in FIG. 1 represent functionally distinct elements; one or more of the constituting elements may be implemented in an integrated form in an actual physical environment.

The microphone 110 may be installed at a location within the vehicle where the user's speech may be received. The user who inputs speech into the microphone 110 may be the driver or a passenger. The microphone 110 may be installed at a location such as the steering wheel, center fascia, headlining, or side mirrors to receive speech input from the driver or passenger.

It is also possible to install two or more microphones to receive speech input from rear seat passengers. The microphone 110 for receiving speech input from rear seat passengers may be installed on the front seat armrest, rear seat armrest, rear seat door, B pillar, or C pillar of the vehicle.

The audio signal input to the microphone 110 may be transmitted to the speech recognition ordering unit 160. Also, the audio signal may be transmitted from the communication unit 140 to an external server device.

The interface 150 may receive user commands manually. The interface 150 may be located in an area of the center fascia where Audio Video Navigation (AVN) is installed or an area where a gearbox is installed. The interface 150 may include an input device installed in the form of a button on the steering wheel or a jog shuttle.

To receive an order command from the passenger's seat position, the interface 150 may include an input device installed on the door of each seat and may include an input device installed on the armrest of the front seat or the armrest of the rear seat. The input device may include a touchpad integrated with the display.

The interface 150 may include an AVN display, a cluster display, or a head-up display (HUD) installed on the center fascia of the vehicle. The interface 150 may include a rear seat display mounted on the back of the front seat headrest, allowing passengers in the rear seat to view the video display. In the case of a multi-passenger vehicle, the interface 150 may include a display mounted on the headlining. The display may be installed at any location visible to the passengers of the vehicle, with no restrictions on the number or placement of the displays.

The sensor unit 130 includes a pressure sensor for detecting seat occupancy, a motion sensor, a touch sensor, a sensor for collecting biometric signals, an infrared sensor, an acceleration sensor, and a wheel revolution sensor.

The sensor unit 130 may include a camera. The camera may capture at least one or more of the interior or exterior images of the vehicle. The camera may be positioned to face the inside of the vehicle or directed to the outside.

The communication unit 140 may exchange signals with other communication devices using at least one of various wireless communication methods such as Bluetooth, 4G communication, 5G communication, or Wi-Fi. The communication unit 140 may exchange information with other communication devices via a cable connected to a Universal Serial Bus (USB) port, auxiliary (AUX) port, and the like.

The communication unit 140, equipped with two or more communication interfaces that support different communication methods, may transmit and receive signals and information to and from two or more devices.

For example, the communication unit 140 may communicate with a mobile device located inside the vehicle to receive information acquired by the mobile device or stored in the mobile device (user's video, user's speech, contact information, schedule, and so on). The communication unit 140 may transmit the user's speech by communicating with the server through 4G or 5G communication and may receive signals needed to provide a service desired by the user. Also, the communication unit 140 may transmit and receive necessary signals to and from the server using a mobile device connected to the vehicle.

The speech recognition ordering unit 160 may place orders from respective seat positions of the passengers using seat information and speech information.

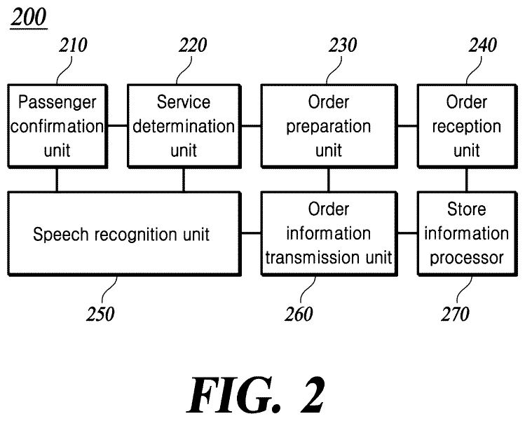

FIG. 2 illustrates a structure of a speech recognition ordering apparatus according to an embodiment of the present disclosure.

The speech recognition ordering unit 160 of FIG. 1 may functionally correspond to the speech recognition ordering apparatus 200 of FIG. 2.

The speech recognition ordering apparatus 200 according to an embodiment of the present disclosure may include all or some of a passenger confirmation unit 210, a service determination unit 220, an order preparation unit 230, an order reception unit 240, a speech recognition unit 250, an order information transmission unit 260, and a store information processor 270. Not all blocks shown in FIG. 2 are essential components, and some of the blocks included in the speech recognition ordering apparatus 200 may be added, modified, or deleted. The constituting elements shown in FIG. 2 represent functionally distinct elements; however, one or more of the constituting elements may be implemented in an integrated form in an actual physical environment.

The passenger confirmation unit 210 utilizes the sensor unit 130 to determine the number of people on board the vehicle. The passenger confirmation unit 210 may store information on the number of people on board the vehicle. Passenger information is shown in Table 1.

TABLE 1

| Driver's | Passenger | 2nd row | 2nd row | 3rd row | 3rd row | 3rd row |
|---|---|---|---|---|---|---|
| seat | seat | left | right | left | center | right |
| ◯ | ◯ | X | ◯ | X | X | X |

For example, Table 1 shows an example in which the vehicle's seating arrangement includes a driver's seat, a passenger seat, a 2nd row left seat, a 2nd row right seat, a 3rd row left seat, a 3rd row center seat, and a 3rd row right seat. When a seat is occupied, it is indicated with an ‘o’ mark. When a seat is not occupied, it is indicated with an ‘x’ mark.

In the present disclosure, order type refers to the category of an order. Order types include an individual order and a group order. An individual order refers to an order placed by each passenger. A group order refers to a consolidated order placed by the driver who combines the orders of all passengers into one. The passenger confirmation unit 210 may identify the order type and, in the case of individual order, record information on the number of people on board the vehicle. In the case of group order, the passenger confirmation unit 210 indicates that only the driver's seat is occupied. For example, ‘o’ is displayed in the driver's seat information field. The user may manually change the passenger position to a position other than the driver's seat. Accordingly, the pickup position may be changed to the position other than the driver's seat.

The service determination unit 220 may recognize a wake-up word that triggers speech recognition ordering service. The service determination unit 220 may determine order attributes based on the order type. For example, individual orders may involve each passenger ordering items for personal consumption, such as coffee or hamburgers. A group order may involve the driver ordering items to be shared and consumed by multiple people, such as pizza, braised pigs' feet, or Tteokbokki. Users may select a store before placing their order. Users may select the store by considering the vehicle's driving path.

The order preparation unit 230 generates an order table and generate information based on the passenger information. The order table may include an order type, service name, order information, estimated arrival time, passenger position information, seat occupancy information, and order code. The order preparation unit 230 may generate an order table that includes the information shown in Table 2.

TABLE 2

| Order | Seat occupancy | | |
|---|---|---|---|
| code | information | Passenger position | Order type |
| — | ◯ | Driver's seat (Oc1) | Individual order |
| — | ◯ | Passenger seat (Oc2) | Service name |
| — | X | 2nd row left (Oc3) | Starbucks order |
| — | ◯ | 2nd row right (Oc4) | Order information |
| — | X | 3rd row left (Oc5) | Vehicle number |
| | | | (order number) |
| — | X | 3rd row center (Oc6) | Estimated arrival time |
| — | X | 3rd row right (Oc7) | After 20 minutes |

The order type indicates the category of an order. The service name identifies the service provider on which the order is being placed. The order information includes a vehicle number and an order number. The estimated arrival time indicates the time needed to reach the service provider's location. Passenger position and seat occupancy information are based on the passenger information generated by the passenger confirmation unit 210.

The order reception unit 240 receives orders from vehicle passengers and collects speech signals to create an order table. The order reception unit 240 may collect speech signals using speech recognition. The order reception unit 240 may transmit the collected speech signals to the speech recognition unit 250.

The order reception unit 240 performs speech recognition for processing the order when the service determination unit 220 recognizes the wake-up word that triggers speech recognition. For example, the order reception unit 240 may use the vehicle's speaker to output a speech, saying, “Starbucks (service name) ordering is starting.”

The order reception unit 240 may receive orders from passengers based on their seat positions using the passenger position information in the order table. For example, using Table 2, the order reception unit 240 may receive orders from passengers sequentially from the left to the right across the table. The order reception unit 240 may output a speech that asks for an order to the speaker of each occupied seat marked with ‘o’ in the seat occupancy information. For example, the order reception unit 240 may output a speech asking for an order to the speaker of each seat in the sequence of the driver's seat, passenger seat, and 2nd row right seat. The speech asking for an order may be something like “Please tell me the menu you want.”

The order reception unit 240 may generate position information of the seat from which an order is currently received. Seat position information may be generated in the form of ‘OcN’. For example, the order reception unit 240 may generate position information as ‘Oc1’ for the driver's seat and ‘Oc2’ for the passenger seat. The order reception unit 240 may transmit seat position information to the speech recognition unit 250.

The order reception unit 240 may transmit the content of the passenger's speech to the speech recognition unit 250. The order reception unit 240 may receive the speech recognition processing content and input the order code into the order table.

The order reception unit 240 inputs the order code and then generates an order number and estimated arrival time. In the present disclosure, the order number refers to the vehicle number. The estimated arrival time refers to the time calculated using a navigation device to reach the store where the order has been placed.

The order reception unit 240 may transmit the completed order table to the order information transmission unit 260.

The speech recognition unit 250 may generate order code information using the passenger's speech signal.

The order information transmission unit 260 transmits the completed order table to the server of the store where the order has been placed. The order information transmission unit 260 may update the estimated arrival time based on the road traffic conditions. The order information transmission unit 260 compares the time of transmitting the order table with the updated estimated arrival time. When the difference exceeds 5 minutes, the order information transmission unit 260 may update the ‘vehicle information (order information)’ and ‘estimated arrival time’ information to provide a new order table.

The store information processor 270 may receive pickup preparation information from the store where the order has been placed. When receiving pickup preparation information, the store information processor 270 may indicate using the vehicle's TTS or a screen pop-up that the ordered item is ready for pickup.

The store information processor 270 may receive pickup start information from the store where the order has been placed. After receiving the pickup start information, the store information processor 270 may lower the window or open the door corresponding to the location where the ordered item should be picked up.

The store information processor 270 may receive pickup position information from the store where the order has been placed. The store information processor 270 may use the pickup position information to determine which window among the front, rear, left, and right windows of the vehicle should be opened.

The store information processor 270 may receive pickup completion information from the store where the order has been placed. When receiving pickup completion information, the store information processor 270 may, for example, announce “The door will be closed” and then close the opened door or raise the lowered window.

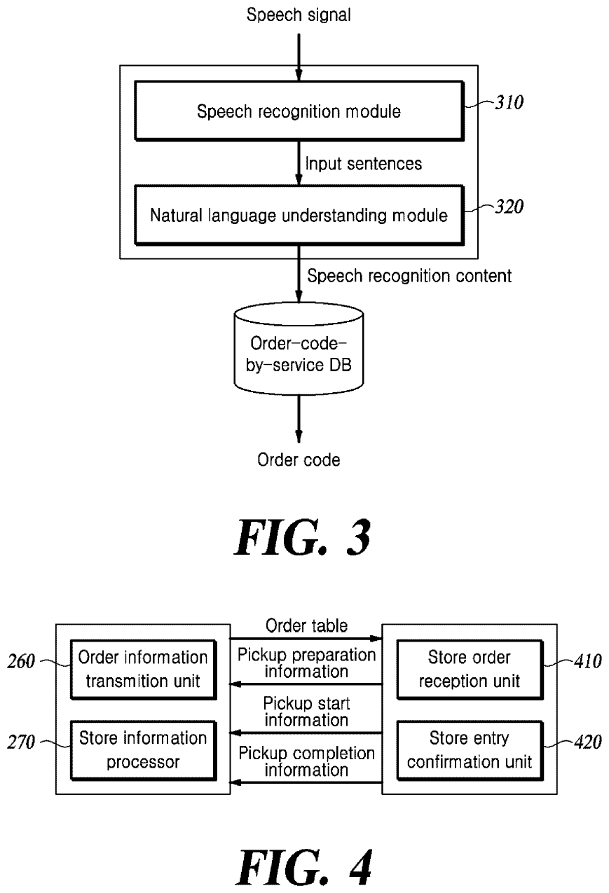

FIG. 3 illustrates a structure of a speech recognition system according to an embodiment of the present disclosure.

Referring to FIG. 3, the speech recognition unit 250 may understand the user's utterance and provide a response corresponding to the user's utterance. In the present disclosure, the user may refer to the driver or a passenger.

The speech recognition unit 250 includes a speech recognition module 310 and a natural language understanding module 320. The speech recognition module 310 may transform the user's utterance and speech command to text. The natural language understanding module 320 may determine the user's order intent.

The speech recognition module 310 acquires the user's utterance received from the microphone in the vehicle and converts the user's utterance into an input sentence using at least one Speech to Text (STT) engine. The STT engine may convert speech signals into text by applying a speech recognition algorithm or a deep learning model to the speech signal representing the user's utterance. For example, the speech recognition module 310 may extract a feature vector from the user's utterance by applying a feature vector extraction technique such as the Cepstrum, Linear Predictive Coefficient (LPC), Mel Frequency Cepstral Coefficient (MFCC), or filter bank energy.

The speech recognition module 310 may obtain a recognition content by comparing an extracted feature vector with a trained reference pattern. The speech recognition module 310 may use an acoustic model or a language model.

The speech recognition module 310 may convert the user's utterance into input sentences in the form of text based on a model employing machine learning or deep learning.

The natural language understanding module 320 receives an input sentence and classifies the utterance intent. The utterance intent refers to the passenger's order intent. In the present disclosure, the classified utterance intent is referred to as a speech recognition content. The natural language understanding module 320 may classify the utterance intent using tokenization or deep learning model.

The speech recognition unit 250 may generate an order code by comparing the speech recognition content with an order-code-by-service database. The order-code-by-service database may be stored in the memory of the speech recognition ordering apparatus according to an embodiment of the present disclosure. The order-code-by-service database contains information on the order codes according to speech recognition contents. The speech recognition unit 250 may generate an order content in the form of ‘(order location)=(order code).’ When the speech recognition unit 250 determines that the user has not placed an order, the speech recognition unit 250 inputs ‘null’ in the (order code). For example, when the user expresses their intention not to place an order by saying ‘skip,’ ‘no need,’ ‘don't want to order,’ or ‘no thanks,’ the speech recognition unit 250 may input information in the form of ‘(order location)=null.’ The speech recognition unit 250 may transmit the generated speech recognition content and order code to the order preparation unit 230.

FIG. 4 illustrates a method for exchanging information between a vehicle and a reception desk of a store according to an embodiment of the present disclosure.

The vehicle may include an order information transmission unit 260 and a store information processor 270. The store's reception desk may include a store order reception unit 410 and a store entry confirmation unit 420. The order information transmission unit 260 and the store information processor 270 may communicate with the store order reception unit 410 and the store entry confirmation unit 420.

The order information transmission unit 260 transmits a completed order table to the server of the store where the order has been placed. The order information transmission unit 260 may update the estimated arrival time based on road traffic conditions and other information. The order information transmission unit 260 may compare the time when the order table has been transmitted and the updated estimated arrival time; for example, when the difference exceeds 5 minutes, the order information transmission unit 260 may update the ‘vehicle information (order information)’ and ‘estimated arrival time’ and transmit a new order table.

The store information processor 270 may receive pickup preparation information from the store where the order has been placed. When receiving the pickup preparation information, the store information processor 270 may indicate using the vehicle's TTS or a screen pop-up that the ordered item is ready for pickup.

The store information processor 270 may receive pickup start information from the store where the order has been placed. After receiving the pickup start information, the store information processor 270 may lower the window or open the door corresponding to the location where the ordered item should be picked up.

The store information processor 270 may receive pickup position information from the store where the order has been placed. The store information processor 270 may use the pickup position information to determine which window among the front, rear, left, and right windows of the vehicle should be opened.

The store information processor 270 may receive pickup completion information from the store where the order has been placed. When receiving pickup completion information, the store information processor 270 may, for example, announce “The door will be closed” and then close the opened door or raise the lowered window.

The store order reception unit 410 may receive an order table from the vehicle. The store order reception unit 410 may adjust the preparation sequence of the received orders using the estimated arrival time information of the order table. The store order reception unit 410 may adjust the preparation sequence when the estimated arrival time information is updated. For example, it is possible to deliver pre-prepared items to other customers first.

When the preparation of an ordered item is completed, the store order reception unit 410 may transmit pickup preparation information to the vehicle. When the preparation of the ordered item is completed, the store order reception unit 410 may switch to the vehicle entry monitoring step. In the present disclosure, the vehicle entry monitoring step checks whether the vehicle arrives at the store entrance after the preparation of the ordered item is completed.

When in the vehicle entry monitoring step, the store entry confirmation unit 420 checks whether a vehicle is entering the store. The store entry confirmation unit 420 may check the vehicle number and provide items according to the order number. In the present disclosure, the place where items are prepared and placed is called a pickup table. The pickup table may include an object recognition sensor and an image recognition sensor. An object recognition sensor may be located on the bottom of the pickup table where the ordered item is placed. An image recognition sensor may be located above the pickup table where the ordered item is placed. The store entry confirmation unit 420 uses a sensor to accurately determine the location of the ordered item and provides the ordered item. The store entry confirmation unit 420 may accurately deliver the ordered items to the person who ordered them based on the vehicle number and passenger location information. The store entry confirmation unit 420 may individually provide the ordered items on the pickup table based on the passenger's position information. For example, when the passenger at the driver's seat orders an Americano, the store entry confirmation unit 420 places the Americano at the position of the pickup table corresponding to the driver's seat. When a passenger in the front passenger seat orders a café latte, the store entry confirmation unit 420 may place the café latte at the position of the pickup table corresponding to the passenger seat. Accordingly, the store entry confirmation unit 420 may provide ordered items individually according to the seat positions.

When the vehicle arrives at the item pickup position, the store entry confirmation unit 420 transmits pickup start information to the vehicle. The store entry confirmation unit 420 transmits pickup position information to the vehicle along with the pickup start information. The pickup position information includes information on the position for picking up the ordered items.

The store entry confirmation unit 420 transmits pickup completion information to the vehicle when the ordered items are picked up.

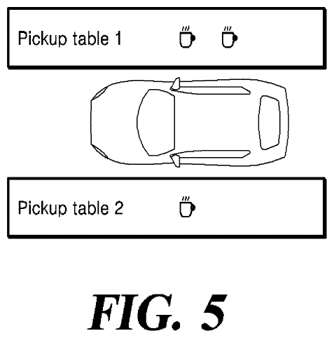

FIG. 5 illustrates a method for providing an item using a pickup table according to an embodiment of the present disclosure.

Referring to FIG. 5, a pickup table may be located on the left and right sides of the vehicle. The vehicle may enter between the pickup tables. When the vehicle arrives at a position where an ordered item may be picked up, the store entry confirmation unit 420 transmits pickup start information to the vehicle.

Referring to the example of the order table of Table 2, positions of the passengers who have ordered drinks are the driver's seat, passenger seat, and 2nd row right seat. Accordingly, the store entry confirmation unit 420 provides the ordered items on the pickup tables so that the ordered drinks may be served to the driver's seat, passenger seat, and 2nd row right seat.

The vehicle may lower the window or open the door to pick the drinks. Referring to the example of the order table of Table 2, the windows or doors for the driver's seat, passenger seat, and 2nd row right seat may be lowered or opened. Passengers may receive their ordered items at their respective seats.

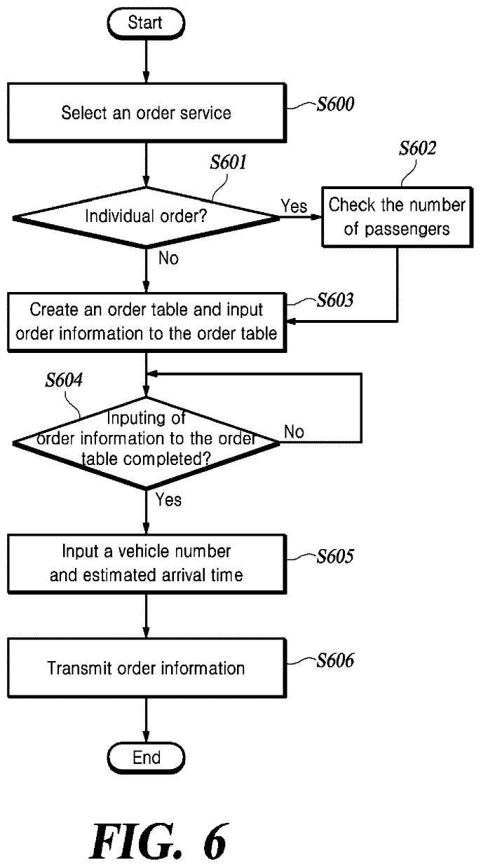

FIG. 6 is a flow diagram illustrating a process for generating order information by a speech recognition ordering apparatus according to an embodiment of the present disclosure.

The user selects a speech recognition-based order service method S600. The order service method includes manual methods and methods using speech recognition. The manual method is a method in which the user directly inputs an order while viewing the navigation screen. A method using speech recognition is a method in which an order is entered using the user's speech.

The service determination unit 220 may recognize a wake-up word that triggers speech recognition. The user may select menus using the speech recognition-based order service method.

The speech recognition ordering apparatus determines whether the user's order is an individual order or a group order S601. An individual order refers to an order placed by each passenger. A group order refers to a consolidated order placed by the driver who combines the orders of all passengers into one.

When the user's order is determined as an individual order, the speech recognition ordering apparatus determines the number of passengers on board the vehicle S602.

When the user's order is determined as a group order, the speech recognition ordering apparatus creates an order table S603. When the user's order is an individual order, the speech recognition ordering apparatus creates an order table based on the information on the passengers on board the vehicle.

The order preparation unit 230 creates an order table based on the passenger information. The order table may include an order type, service name, order information, estimated arrival time, passenger position information, seat occupancy information, and order code.

The order reception unit 240 receives the passenger's order and inputs the order information into the created order table. The order reception unit 240 receives the passenger's order and collects speech signals to be entered into the order table.

The order reception unit 240 performs speech recognition for processing the order when the service determination unit 220 recognizes the wake-up word that triggers speech recognition. The order reception unit 240 may collect speech signals by recognizing the passengers' speeches (e.g., words). The order reception unit 240 may deliver the collected speech signals to the speech recognition unit 250. The order reception unit 240 may receive the orders of the passengers in the order of seats using the passenger position information in the order table. The order reception unit 240 may generate position information of the seat from which an order is currently received. The order reception unit 240 may transmit the content of the passenger's speech to the speech recognition unit 250. The speech recognition unit 250 may generate order code information using the passenger's speech signal. The order reception unit 240 may receive the speech recognition processing content and input the order code into the order table.

The speech recognition ordering apparatus checks whether all information generated in the order table has been entered S604. When all information has not been entered yet, the speech recognition ordering apparatus may re-enter the information into the order table.

After completely entering all of the information into the order table, the speech recognition ordering apparatus 200 generates the order number and estimated arrival time information. The speech recognition ordering apparatus enters the generated order number and estimated arrival time information into the order table S605. The order information transmission unit 260 may update the estimated arrival time based on the road traffic conditions. The order information transmission unit 260 compares the transmission time of the order table with the updated estimated arrival time. When the difference exceeds 5 minutes, the order information transmission unit 260 may update the ‘vehicle information (order information)’ and ‘estimated arrival time’ information to provide a new order table.

In the present disclosure, the order number refers to the vehicle number. The estimated arrival time refers to the time calculated using a navigation device to reach the store where the order has been placed. The order reception unit 240 may transmit the completed order table to the order information transmission unit 260.

The speech recognition ordering apparatus transmits the completed order table to the server of the store where the order has been placed S606.

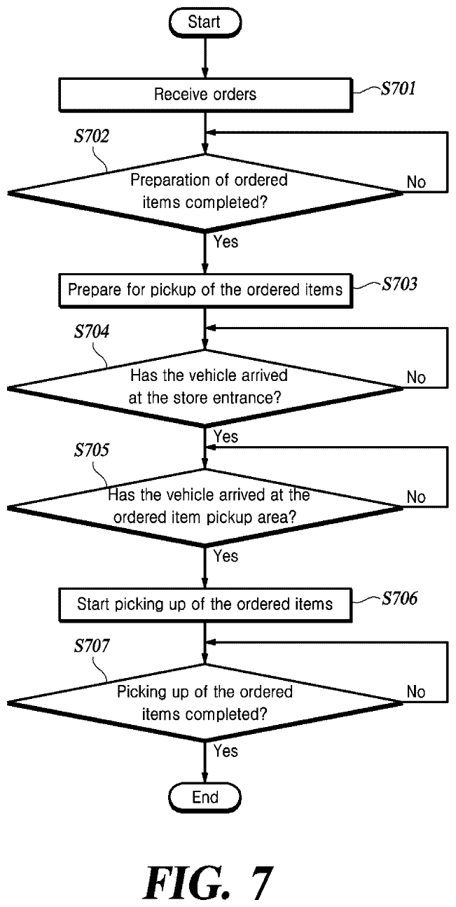

FIG. 7 is a flow diagram illustrating a process of picking up an ordered item in a store according to an embodiment of the present disclosure.

The store order reception unit 410 checks whether an order has been received from the vehicle S701. The store order reception unit 410 may receive an order table from the vehicle.

The store order reception unit 410 may check whether the item ordered by the passenger is ready S702. The store order reception unit 410 may adjust the preparation sequence of the received orders using the estimated arrival time information of the order table. The store order reception unit 410 may adjust the preparation sequence when the estimated arrival time information is updated. For example, it is possible to deliver pre-prepared items to other customers first.

When the preparation of an ordered item is completed, the store order reception unit 410 may transmit pickup preparation information to the vehicle S703. When receiving the pickup preparation information, the vehicle may provide the passengers with a message or a speech signal, for example, “The ordered item is ready.” When the preparation of the ordered item is completed, the store order reception unit 410 may switch to the vehicle entry monitoring step. The vehicle entry monitoring step checks whether the vehicle arrives at the store entrance after the preparation of the ordered item is completed.

The store entry confirmation unit 420 may check whether a vehicle is entering the store S704. The store entry confirmation unit 420 may check the vehicle number using a camera or a vehicle recognition system. When confirming that the vehicle has entered the store, the store entry confirmation unit 420 may prepare the ordered items and place them on the pickup table.

The store entry confirmation unit 420 may check whether the vehicle has arrived at the pickup area.

When the vehicle arrives at the pickup location, the store entry confirmation unit 420 transmits pickup start information to the vehicle S706. Upon receiving the pickup start information, the vehicle may provide the passengers with a message or a speech prompt, for example, “The window/door opens automatically to pick up the item.” The store entry confirmation unit 420 transmits the pickup position information to the vehicle along with the pickup start information. The pickup position information includes information on the location at which to pick up the ordered items. The vehicle may lower the window or open the door corresponding to the seat of the passenger who has placed the order based on the pickup start information and pickup position information.

The store entry confirmation unit 420 uses a sensor to accurately determine the location of the ordered item and provides the ordered item. The store entry confirmation unit 420 may accurately deliver the ordered items to the person who ordered them based on the vehicle number and passenger location information. The store entry confirmation unit 420 may individually provide the ordered items on the pickup table based on the passenger's position information.

The store entry confirmation unit 420 transmits pickup completion information to the vehicle when the ordered items are picked up S707. When receiving the pickup completion information, the vehicle may provide a message or a speech prompt to the passengers, for example, “Pickup of the ordered items has been completed. The window will be automatically closed. Please be careful.” After the pickup is completed, the vehicle may automatically raise the windows or close the doors.

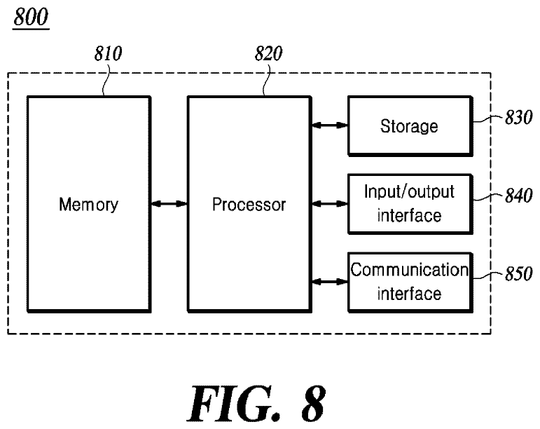

FIG. 8 is a block diagram briefly illustrating a computing device that may be used for implementing a method or an apparatus according to the present disclosure.

The computing device 800 may include all or some of a memory 810, a processor 820, a storage 830, an input/output interface 840, and a communication interface 850. The computing device 800 may structurally and/or functionally include at least a portion of the speech contents of the processor 820 through the output device.

The communication interface 850 may provide access to an external network. The computing device 800 may communicate with other devices through the communication interface 850.

Each element of the apparatus or method in accordance with the present disclosure may be implemented in hardware or software, or a combination of hardware and software. The functions of the respective elements may be implemented in software, and a microprocessor may be implemented to execute the software functions corresponding to the respective elements.

Various embodiments of systems and techniques described herein can be realized with digital electronic circuits, integrated circuits, field programmable gate arrays (FPGAs), application specific integrated circuits (ASICs), computer hardware, firmware, software, and/or combinations thereof. The various embodiments can include implementation with one or more computer programs that are executable on a programmable system. The programmable system includes at least one programmable processor, which may be a special purpose processor or a general purpose processor, coupled to receive and transmit data and instructions from and to a storage system, at least one input device, and at least one output device. Computer programs (also known as programs, software, software applications, or code) include instructions for a programmable processor and are stored in a “computer-readable recording medium.”

The computer-readable recording medium may include all types of storage devices on which computer-readable data can be stored. The computer-readable recording medium may be a non-volatile or non-transitory medium such as a read-only memory (ROM), a random access memory (RAM), a compact disc ROM (CD-ROM), magnetic tape, a floppy disk, or an optical data storage device. In addition, the computer-readable recording medium may further include a transitory medium such as a data transmission medium. Furthermore, the computer-readable recording medium may be distributed over computer systems connected through a network, and computer-readable program code can be stored and executed in a distributive manner.

Although operations are illustrated in the flowcharts/timing charts in the specification as being sequentially performed, this is merely a description of the technical idea of one embodiment of the present disclosure. In other words, those having ordinary skill in the art to which an embodiment of the present disclosure belongs may appreciate that various modifications and changes can be made without departing from essential features of an embodiment of the present disclosure. The sequence illustrated in the flowcharts/timing charts can be changed and one or more operations of the operations can be performed in parallel. Thus, flowcharts/timing charts are not limited to the temporal order.

Although embodiments of the present disclosure have been described for illustrative purposes, those having ordinary skill in the art should appreciate that various modifications, additions, and substitutions are possible, without departing from the idea and scope of the claimed disclosure. Therefore, embodiments of the present disclosure have been described for the sake of brevity and clarity. The scope of the technical idea of the present embodiments is not limited by the illustrations. Accordingly, it should be apparent to one of ordinary skill in the art that the scope of the claimed disclosure is not to be limited by the above explicitly described embodiments but by the claims and equivalents thereof.

What is claimed is:

1. A method for providing a verbal order based on seat position, the method comprising:
identifying a seat position of each passenger;
generating order information for each occupied seat based on the identified seat position of each passenger; and
transmitting the order information to a store where the order is placed.

2. The method of claim 1, wherein the generating order information comprises recognizing a wake-up word to trigger speech recognition,
wherein speech recognition comprises acquiring an order of a passenger, and converting the order into text.

3. The method of claim 1, wherein the generating order information comprises receiving an order of each passenger based on a sequence of the seat positions.

4. The method of claim 1, wherein the generating order information comprises outputting a speech prompt that requests orders from each passenger based on a sequence of the seat positions and sequentially obtaining utterances from each passenger.

5. The method of claim 1, wherein the generating order information comprises generating an order code by comparing speech recognition content of each passenger with an order-code-by-service database.

6. The method of claim 1, wherein the transmitting the order information comprises transmitting updated order information based on an updated estimated arrival time based on road traffic conditions.

7. The method of claim 1, wherein the order information comprises at least one of speech recognition content of a passenger, an order code, an order type, order information, estimated arrival time, and a passenger position.

8. The method of claim 1, further comprising:
preparing for pickup of an ordered item based on the seat position.

9. The method of claim 8, wherein the preparing for the pickup of the ordered item comprises determining which windows or doors, among a front side, a rear side, a left side, and a right side of a vehicle, are opened based on the seat position of a passenger who has placed an order.

10. An apparatus for providing a verbal order based on seat position, the apparatus comprising:
at least one memory storing instructions; and
at least one processor,
wherein, by executing the instructions, the at least one processor is configured to perform:
identifying a seat position of each passenger;
generating order information for each occupied seat based on the identified seat position of each passenger; and
transmitting the order information to a store where the order is placed.

11. The apparatus of claim 10, wherein the generating order information comprises recognizing a wake-up word to trigger speech recognition,
wherein speech recognition comprises acquiring an order of a passenger, and converting the order into text.

12. The apparatus of claim 10, wherein the generating order information comprises receiving an order of each passenger based on a sequence of the seat positions.

13. The apparatus of claim 10, wherein the generating order information comprises outputting a speech prompt that requests orders from each passenger based on a sequence of the seat positions and sequentially obtaining utterances from each of passenger.

14. The apparatus of claim 10, wherein the generating order information comprises generating an order code by comparing speech recognition content of each passenger with an order-code-by-service database.

15. The apparatus of claim 10, wherein the transmitting the order information comprises transmitting updated order information based on an updated estimated arrival time based on road traffic conditions.

16. The apparatus of claim 10, wherein the order information comprises at least one of: speech recognition content of a passenger, an order code, an order type, order information, estimated arrival time, and a passenger position.

17. The apparatus of claim 10, further comprising:
preparing for pickup of an ordered item based on the seat position.

18. The apparatus of claim 17, wherein the preparing for the pickup of the ordered item comprises determining which windows or doors, among a front side, a rear side, a left side, and a right side of a vehicle, are opened based on the seat position of a passenger who has placed an order.
